(19) United States
(12) Patent Application Publication
(10) Pub. No.: US 2010/0200608 A1
(43) Pub. Date: Aug. 12, 2010

(54) CONTAINER

(75) Inventor: Richard Pryor, Essex (GB)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Dairy Crest Limited, Esher (GB)

(21) Appl. No.: 12/702,905

(22) Filed: Feb. 9, 2010

(30) Foreign Application Priority Data
Feb. 10, 2009 (GB) 0902172.6

(51) Int. Cl. B67D 1/00; B65D 35/56

(52) U.S. Cl. 222/1; 222/83; 222/105; 222/465.1

(57) ABSTRACT

A container for dispensing liquid such as milk, from a bag, includes a clamp to secure an ear of the bag to the container rim, and a lid with a piercing member to dispense the liquid. The piercing member pierces the bag adjacent the clamp as the lid is closed.

### CROSS-REFERENCE TO RELATED APPLICATION

This application claims foreign priority to United Kingdom Patent Application No. 0902172.6 filed Feb. 10, 2009, which is herein incorporated by reference in its entirety.

### TECHNICAL FIELD

This invention relates to a container, particularly a jug, for use in dispensing liquids from a flexible bag or pouch.

### BACKGROUND

Liquid such as milk may be transported and sold to consumers in disposable, flexible bags. These bags have the advantage that they use substantially less plastics material than the rigid plastic containers commonly used for this purpose. However, it is difficult to dispense liquid directly from flexible bags. It has therefore been desirable to decant the liquid by cutting off an ear of the bag, and pouring the liquid from the bag, for example into a re-usable rigid container or jug. This can be difficult to achieve without spillage. Alternatively, the bag may be placed in a jug with an ear of the bag cut off, such that the jug assists in holding the bag during pouring directly from the bag. However this also causes problems with spillage from the bag, which is “loose” in the jug, and the “pour” from the bag can be highly variable dependant on how accurate the cut off is. Also the bag cannot be closed once it has been cut open, which can lead to deterioration of the product inside.

Various re-usable containers have been proposed for accepting a flexible bag, making an aperture in the bag, and dispensing the liquid from the aperture. Some such arrangements include a cutter member for making the aperture, and these arrangements usually push down on the bag within the container so as to hold it in place firmly enough to be cut. A problem with such an arrangement is that the contents of the bag are under some pressure, and tend to spurt out upon cutting.

U.S. Patent Publication No. 2009/0108001 discloses a container in which opposing ears of the bag are clamped between the body and lid so as to hold the top of the bag taut. A piercing member may then be pushed into the bag. While the arrangement works well, in some cases it may be difficult for a user to hold both ears over the edges of the jug body while simultaneously closing the lid to clamp the bag.

### SUMMARY

According to some embodiments of the present invention, there is provided a container for dispensing liquid from a flexible bag, the container including: a body having an opening for accepting the bag, the body being configured to be engageable with an upper portion of the bag adjacent the opening for securing the bag to the body; a lid for the opening; and a piercing member communicating with an aperture for dispensing the liquid, the piercing member being movable to be introduced into the container to pierce the bag adjacent the said upper portion of the bag.

Thus in some instances the bag may be secured to the body before closing the lid, enabling the user more easily to ensure the bag is properly secured.

In some embodiments, the piercing member is associated with the lid, for example mounted in the lid. Thus, the piercing member may be introduced into the container as the lid is closed, removing the need for a separate step of pushing the piercing member into the bag.

In some embodiments, the opening may conveniently be an open top of the body. In some cases, the body portion is engageable with the bag via a clamp for holding a part of the upper portion of the bag, such as an ear of the bag. The clamp is conveniently arranged at or adjacent the rim of the opening. Additionally the lid may be attached to the body by a hinge, and the body and the lid may each include cooperating engagement members for securing the lid to the body, which may for example be provided opposite the hinge.

Thus a bag may be placed in the body portion, and one ear at the top of the bag may be pulled over the rim and clamped in position. The lid may then be closed over the bag and fastened to the body.

In some embodiments, the clamp may include textured cooperating surfacesfor increasing frictional engagement with the bag. Thus when the piercing member pierces the bag, the tendency of the bag to otherwise be pulled out of the clamp may be reduced.

In some embodiments, the piercing member may be mounted closely adjacent an edge of the lid, conveniently adjacent the side which is arranged to be adjacent the clamp, and opposite the hinge when the lid is attached to the body. The piercing member is conveniently a tapered end of a spout, which may for example be tubular, and the opposite end of which may be open to form the dispensing aperture. The spout may be provided with sealing formations such as annular ridges to facilitate sealing of the aperture created in the bag with the piercing member.

In some embodiments, the taper may extend from a piercing point closer to the hinge, up to an opposite region close to the edge of the container clamp. Thus, in some cases, the closing action of the lid tends to pull the bag away from the clamp with the piercing point piercing the bag, and stretch the aperture around the spout.

In some embodiments, the spout may be mounted in a spout body fitting into a recess in the lid. The open end of the spout may be provided with a movable cover member, such as a hinged cover for protecting the spout when not in use and sealing the contents of the bag. The spout body may be removably mounted in an aperture in the lid or lid recess, such that it may be removed for cleaning, or may optionally be pushed through the aperture after closing the lid, in order to pierce the bag.

According to some embodiments of the present invention, liquid may be dispensed from a flexible bag by placing the bag in a rigid container body through an opening; securing an upper part of the bag to the body such that it is held above the remainder of the bag; closing the opening with a lid and piercing the upper part of the bag with a piercing member communicating with an aperture for dispensing the liquid.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of a container according to one embodiment of the invention;

FIG. 2 is a perspective view Fi of the container of FIG. 1, with the lid open, according embodiments of the present invention;

FIG. 3 is a cross-sectional side view of the container of FIG. 1, according to embodiments of the present invention;

FIG. 4 is a perspective view of the container of FIG. 1 with a bag inserted, according to embodiments of the present invention;

FIG. 5 is a perspective view of the container of FIG. 1 with a bag inserted according to embodiments of the present invention;

FIG. 6 is a cross-sectional view of the container of FIG. 1 with a bag inserted therein according to embodiments of the present invention; and

FIG. 7 is a cross-sectional view of the container of FIG. 1 with a bag inserted therein and the lid closed according to embodiments of the present invention.

While the invention is amenable to various modifications and alternative forms, specific embodiments have been shown by way of example in the drawings and are described in detail below. The intention, however, is to not limit the invention to the particular embodiments described. On the contrary, the invention is intended to cover all modifications, equivalents, and alternatives falling within the scope of the invention as defined by the appended claims.

### DETAILED DESCRIPTION

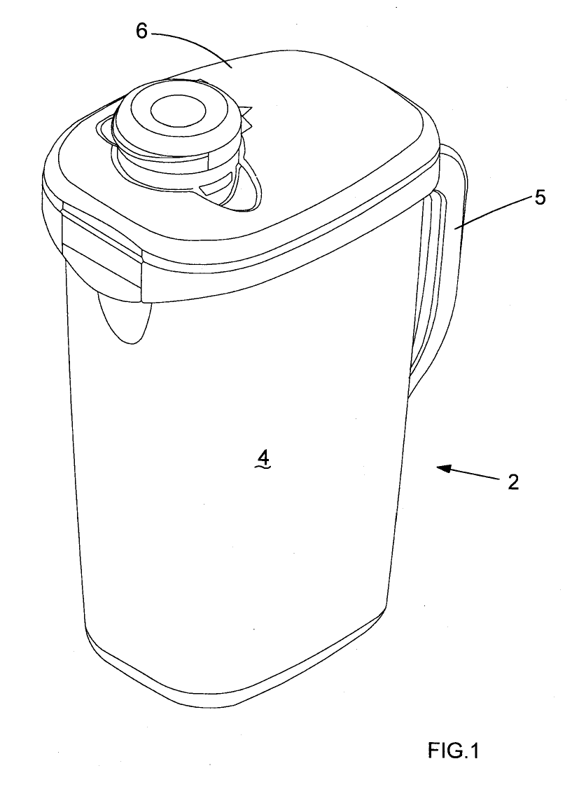

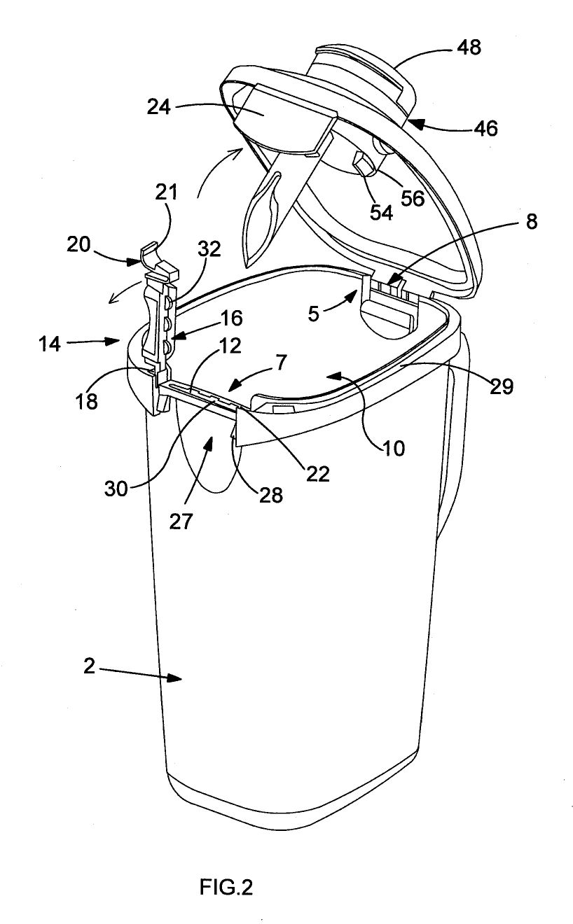

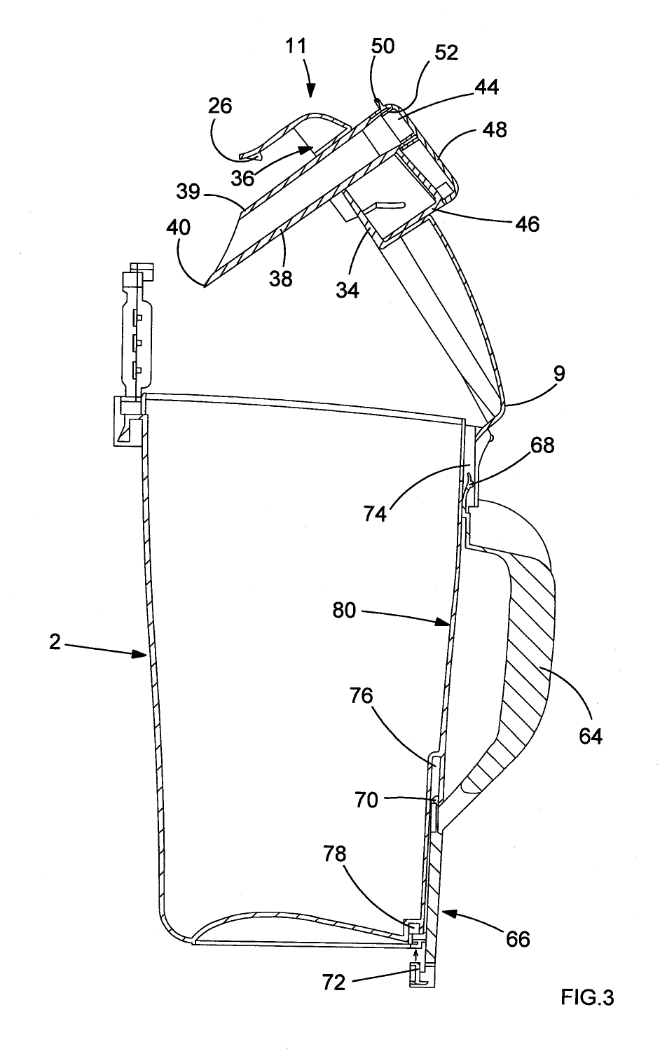

In some embodiments, as illustrated for example in FIG. 1, the liquid dispensing container 2 may be in the form of a jug, having a body portion 4, a lid 6 and a handle 5. As can be seen from FIGS. 2 and 3, the lid 6 may be arranged to cover a generally rectangular opening 10 at the top of the container body 4. At a first side 9, the lid 6 may be joined to a corresponding first side 5 of the opening 10 in the body 4 by a hinge 8. At the opposite second edge 11, the lid 6 is provided with a downwardly extending plate 24 having a ridge 26. The ridge 26 is configured to fit over a pair of cooperating detent members 28 extending downwardly of the body 4 at opposite ends of an inward recess 27 in a rim 29 of the corresponding opposite second edge 7 of the opening 10. In some embodiments, the plate 24 is resilient so as to snap fit onto the body to secure the lid 6 onto the body portion 4.

Also on the second edge 7 of the opening 10, the body portion 4 is provided with a clamp that, in some embodiments, includes a textured clamp surface 12 and a movable clamp member 14. The clamp surface 12 may be slightly downwardly recessed of the rim 29. The clamp member 14 may have a corresponding textured lower surface 16, and may be attached to at one end to the rim 29 by a hinge 18. In this embodiment, the textured surfaces include apertures 30 in the clamp surface 12 and corresponding projections 32 on the clamp member 14. At the opposite end, the clamp member 14 may include a clamp lever 20 for fitting into a lever aperture 22 adjacent the corresponding end of the clamp surface 12. The lever 20 may be resilient so as to snap fit into the aperture 22, and may be provided with a lever arm 21 for releasing the snap fit to undo the clamp member 14.

In some embodiments, as illustrated for example in FIG. 3, the lid 6 includes a shaped indent 34 having an aperture 36 which is sized to receive a piercing member in the form of a tubular spout 38. The first end 40 of the spout 38 is tapered to provide a piercing point. In some instances, the indent 34 is closely adjacent the second edge 11 of the lid 6. The spout body 44 is held within the indent 34 by resilient legs 54 extending through apertures 56 in the lid indent 34 and snap-fitting into place. The spout body 44 is oriented such that the spout 38 is close to the edge of the indent 34 so that the spout 38 is closely aligned when the lid 6 is closed with a portion of the bag 60 held in position by the clamp. In some embodiments, the spout 38 tapers away from that edge from an outer side 39 towards the piercing point 40 at the opposite inner side of the spout 38.

In some embodiments, the second end of the tube 38 forms a dispensing aperture 44 within a larger generally circular spout body 46, having a hinged cover 48. The cover 48 may include a flange 50 for use in opening the cover, and a spout seal 52 for fitting within the spout 44 when closed to seal the contents of the bag 60.

In some embodiments, the handle 5 is removably mounted to the body portion 4 below the hinge 8. As illustrated, the handle 5 has a grip portion 64 and a flush portion 66 for lying adjacent the body portion 4. The handle 5 has upwardly extending tabs 68, 70, 72 at the top, at the bottom of the grip portion 64, and at the bottom of the flush portion 66. Each of the tabs 68, 70, 72 may be shaped to fit closely within corresponding narrow cavities 74, 76, 78 formed in the side 80 of the body portion 4 beneath the hinge 8. Thus the user may slide the handle 5 upwardly to fit it onto the body portion 4, with the weight of the container 2 retaining the handle 5 on the body portion 4 when the container 2 is lifted.

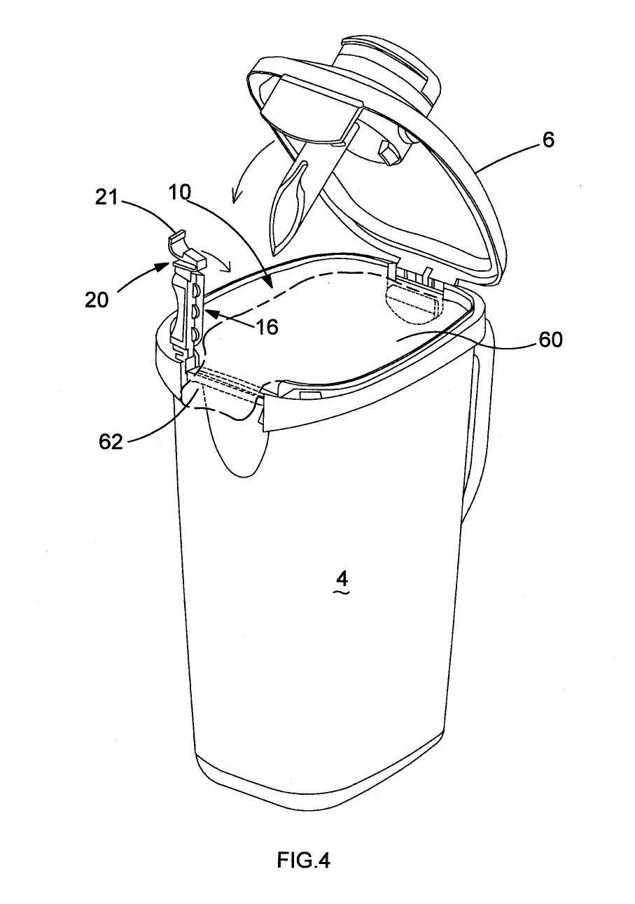

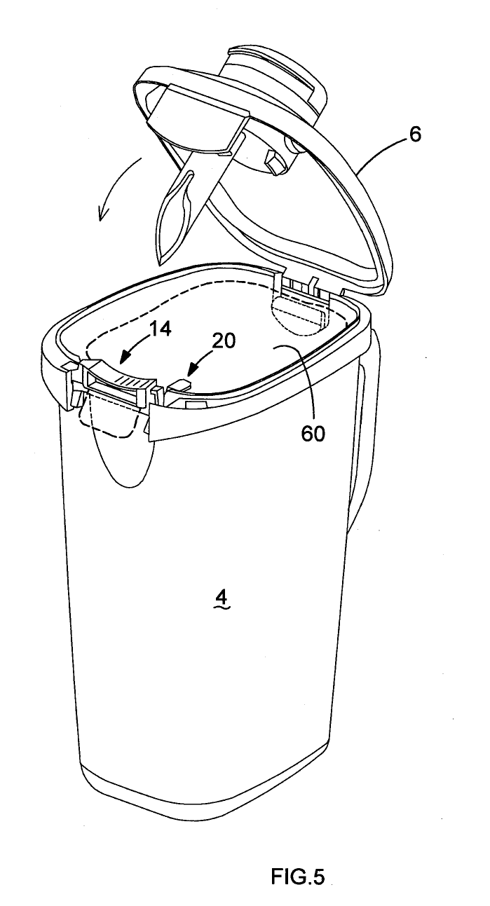

In some embodiments, as shown for example in FIGS. 4 and 5, in use, a flexible bag or pouch 60 may be placed into the body portion 4 of the container 2 via the opening 10. The user may grip an upper corner or ear 62 of the bag 60 and stretch the ear 62 of the bag 60 over the clamp surface 12. In this position, the clamp member 14 is lowered, as indicated by the arrow in FIG. 4, until the underside surface 16 meets the clamp surface 12, and the clamp lever 20 is pushed down into the clamp aperture 22 and snap-fits in. This holds the ear 62 of the bag 60 securely in position between the cooperating textured surfaces 12, 16, as shown in FIG. 5.

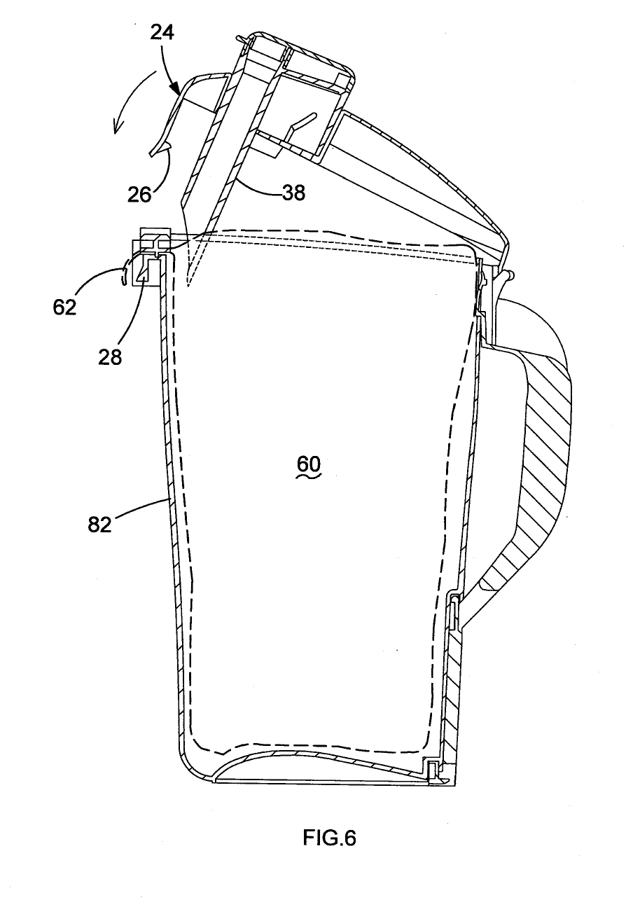

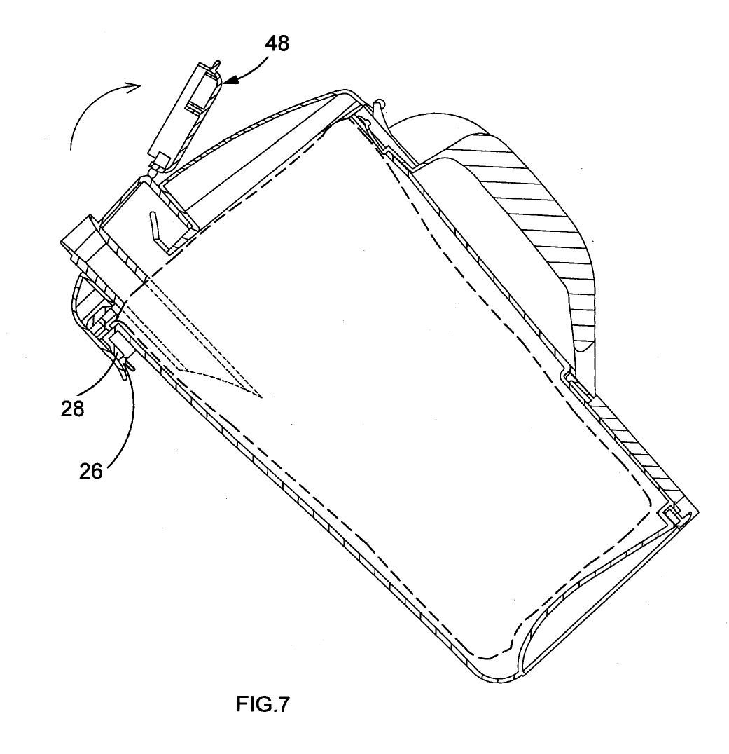

In some embodiments, as illustrated for example in FIGS. 6 and 7, the ear 62 of the bag 60 is thus compressed between the textured surfaces 12 and 16, and is frictionally engaged therebetween. The lid 6 may then be closed, as indicated by the arrow in FIG. 6, such that the sharp end 40 at the inner side of the spout 38 pierces the bag 60 to make a hole immediately adjacent the ear 62.

In some embodiments, as the lid 6 continues to close, the inner side of the spout 38 pulls the bag 60 taut and away from the clamp surface 12 and the clamp member 14. In some cases, the textured surfaces 12 and 16 oppose the tendency for the bag 60 to be pulled out from the clamp surface 12 and the clamp member 14 when the piercing member 38 is pushed down. The aperture thus formed in the bag 60 stretches around the tube 38 allowing the outer side 39 of the spout 38 to be received, and seals against it. The contents of the bag 60 may then be dispensed via the dispensing aperture 44. When the lid 6 is closed, the ridge 26 of the plate 24 engages under the detents 28 to secure the lid 6 to the body portion 4.

In some embodiments, as illustrated, it can be seen that, since the spout is close to the second side 82 of the body portion 4 opposite the handle 5, the last of the contents of the bag 60 is able to drain out of the spout 38. When the bag 60 is empty, the plate 24 is released by pulling it away from the body portion 4 to release the ridge 26 from the detents 28. The lid 6 may then be opened, such that the spout 38 is withdrawn from the bag 60. The clamp member 14 may be released by pushing in the clamp lever arm 21 to release the lever 20 from the aperture 22 in the body. The clamp member 14 may then be lifted, and the bag 60 may be removed and discarded.

Various modifications and additions can be made to the exemplary embodiments discussed without departing from the scope of the present invention. For example, while the embodiments described herein refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A container for dispensing liquid from a flexible bag, the container comprising:
a body having an opening for accepting the bag, the body being configured to be engageable with an upper portion of the bag adjacent the opening for securing the bag to the body;
a lid for the opening; and
a piercing member communicating with an aperture for dispensing the liquid, the piercing member being movable to be introduced into the container to pierce the bag adjacent the said upper portion of the bag.

2. A container for dispensing liquid from a flexible bag as claimed in claim 1, in which the piercing member is associated with the lid.

3. A container for dispensing liquid from a flexible bag as claimed in claim 1, in which the opening is an open top of the body.

4. A container for dispensing liquid from a flexible bag as claimed in claim 1, in which the body is engageable with the upper portion of the bag via a clamp for holding a part of the upper portion.

5. A container for dispensing liquid from a flexible bag as claimed in claim 4, in which the clamp is arranged at or adjacent a rim of the opening.

6. A container for dispensing liquid from a flexible bag as claimed in claim 4, in which the clamp comprises textured cooperating surfaces for frictionally engaging the bag.

7. A container for dispensing liquid from a flexible bag as claimed in claim 1, in which the lid is attached to the body by a hinge.

8. A container for dispensing liquid from a flexible bag as claimed in claim 1, in which the body and the lid comprise cooperating engagement members for securing the lid to the body.

9. A container for dispensing liquid from a flexible bag according to claim 7, in which the piercing member is mounted at a position closely adjacent an edge of the lid.

10. A container for dispensing a liquid from a flexible bag as claimed in claim 9, in which the edge of the lid adjacent the piercing member is substantially opposite the hinge.

11. A container for dispensing liquid from a flexible bag according to claim 7, in which the piercing member is a tapered end of a spout, the opposite end of which forms the aperture.

12. A container for dispensing liquid from a flexible bag as claimed in claim 11, in which the taper extends from an outer part of the spout adjacent the edge of the lid down towards a piercing point on an opposite inner part of the spout closer to the hinge.

13. A container for dispensing liquid from a flexible bag according to claim 11, in which the spout is mounted in a removable spout body arranged to fit into a recess in the lid.

14. A container for dispensing liquid from a flexible bag according to claim 11, in which the aperture of the spout is provided with a movable cover member.

15. A container for dispensing liquid from a flexible bag as claimed in claim 2, in which the opening is an open top of the body.

16. A container for dispensing liquid from a flexible bag according to claim 1, in which the piercing member is mounted at a position closely adjacent an edge of the lid.

17. A container for dispensing liquid from a flexible bag according to claim 1, in which the piercing member is a tapered end of a spout, the opposite end of which forms the aperture.

18. A method of dispensing liquid from a flexible bag comprising:
placing the bag in a rigid container body through an opening;
securing an upper part of the bag to the body such that it is held above the remainder of the bag;
closing the opening with a lid; and
piercing the upper part of the bag with a piercing member communicating with an aperture for dispensing the liquid.
